(19) United States
(12) Patent Application Publication
(10) Pub. No.: US 2004/0045792 A1
(43) Pub. Date: Mar. 11, 2004

(54) Conveying device

(76) Inventor: Ralf Schurmann, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/250,883

(22) PCT Filed: Jan. 15, 2002
(86) PCT No.: PCT/EP02/00317

(30) Foreign Application Priority Data
Jan. 19, 2001 (DE) 101 02 299.9

(51) Int. Cl. B65G 29/00

(52) U.S. Cl. 198/465.1

(57) ABSTRACT

According to the invention, a device (2), which comprises a multitude of assembly carriages (4) and a drive device (12) and which serves to convey these assembly carriages (4), is provided in a process chain used in a production process. Each assembly carriage (4) comprises a drawbar (10) via which the assembly carriages (4) are joined to one another. The assembly carriages (4) are guided on a guide rail (6). At one sole location of the process chain, a drive device (12), alone, drives one of the assembly carriages (4) that are joined to one another by the drawbars (10).

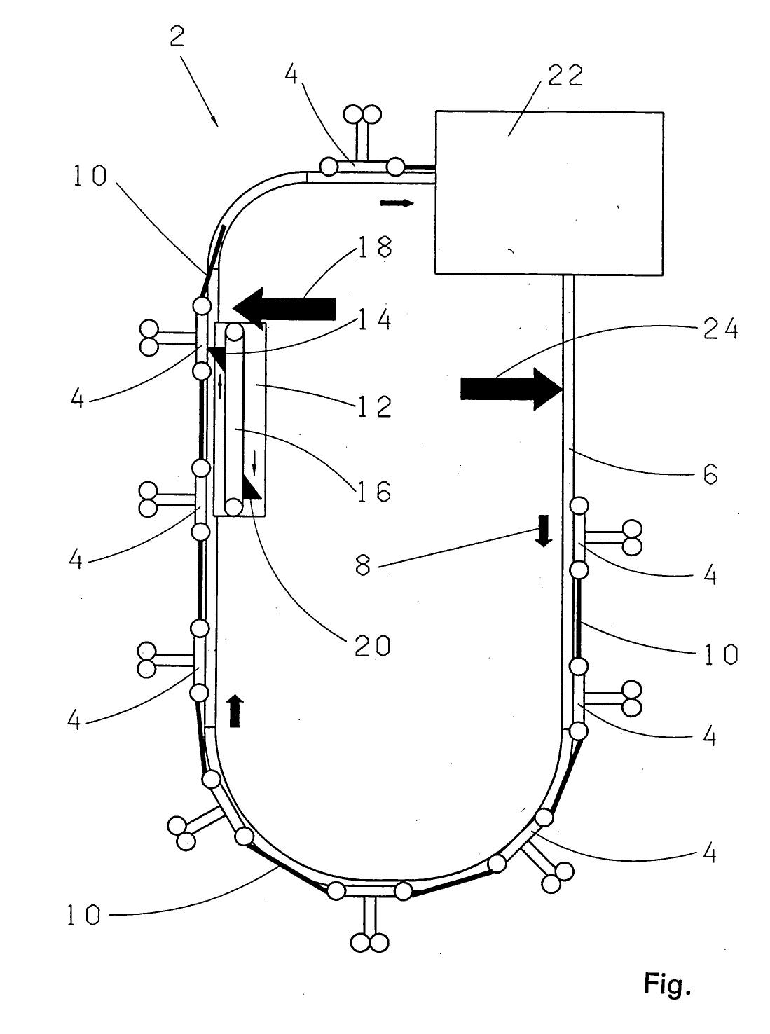

According to the preamble of claim 1, the invention relates to a device for conveying assembly carriages.

During production and testing processes it is required to transport carriers of the parts to be produced or tested to a processing place or a testing place and between said two places. For this purpose, systems or driving systems suspended from the ceiling of the building with assembly carriages on the building floor are usually employed. Different possibilities are known for the conveyance of assembly carriages. Underground chain conveyors have to be fixedly installed in the building floor and require a correspondingly stout building floor in order to arrange the drag chains. The assembly carriages are connected to the chain system and the course of the conveying path is fixedly preset by the floor installation, which makes the system very inflexible. Besides, those systems are very costly due to the expensive components. Driverless transport systems also need an expensive arrangement of signal lines in the building floor. The assembly carriages need a few driving systems and current-supply systems which demand constant charging of the batteries and maintenance. However, the drives characteristic of each assembly carriage do not run synchronously with each other due to scatterings determined by production and thus a jam or pulling apart of the process chain can occur.

The problem on which the invention is based is to provide a device which flexibly and economically ensures a process-safe conveyance of assembly carriages.

The problem is solved by a device having the features of claim 1. Developments are object of sub-claims.

The device for conveying assembly carriages in a process chain has a plurality of assembly carriages and one drive device. Each assembly carriage has one drawbar available by which the assembly carriages can be interconnected. The assembly carriages are guided along a guide rail by means of guide pins which can be detachable, the guide rail presetting the route contour of the production process. On one location of the process chain, one drive device alone drives one of the assembly carriages which are interconnected by the drawbars. In an advantageous development, the drive unit drives the assembly carriage that is leading at the time. Developments have on the drive unit drives which engage in the driven assembly carriages. In one embodiment, the drawbar is flexibly situated on the assembly carriage in order to be able to follow each route contour of the guide rail. One development of the device has the guide rail fastened to the floor. The guide rail can also be located at a distance from the floor so that the carriages can ride thereon.

The invention is explained in detail with reference to a drawing.

The FIGURE shows a process chain with the device 2 for conveyance of assembly carriages 4. A series of assembly carriages are consecutively disposed, in direction of arrow 8 on a guide rail 6 fastened to the floor. The assembly carriages are arranged on the guide rail 6 so as to be forced to follow the preset route contour by the guide rail 6. The assembly carriages 4 have each a drawbar 10 by which the assembly carriages 4 are interconnected. A drive device 12 has two drivers 14, 20 which are disposed on a rotary guide 16, within the drive device 12, spaced apart from one another in a manner such that one of the drivers 14, 20 engages with a respective assembly carriage 4. More than two drivers, for example, three drivers, can be provided. By the drive device 12, the leading assembly carriage 4, at the time, is driven via the first driver 14. In the uncoupled site 18, if the leading assembly carriage 4 abandons the chain of assembly carriages 4, the drawbar 10 of the assembly carriage 4 that follow is uncoupled from the leading assembly carriage 4. Thereby the leading assembly carriage 4 is no longer available as a drawing assembly carriage. Therefore, the second driver 20 engages then with the assembly carriage 4 that follows and conveys the chain further while the first driver 14 disengage from the leading assembly carriage 4. The formerly leading assembly carriage 4 is manually further moved uncoupled while the formerly following assembly carriage 4 now becomes the leading assembly carriage 4. The manually moved assembly carriage 4 is here pushed into a testing bench 22 where added works are effected. At the uncoupled site 24, a new assembly carriage 4 is manually pushed against the end of the chain of the assembly carriages 4 and suspended there while its drawbar 10 is connected with the formerly last assembly carriage 4 of the chain. From there on, it is further drawn by the drive device 12.

The course of the process is again briefly shown herebelow. The assembly carriages 4 previously pushed by co-workers are chained with each other by means of the detachable drawbar 10 and drawn, at a constant velocity, through the assembly line. The assembly carriages 4 are maintained in the track of the guide rail 6. Always only the assembly carriage 4, leading at the time, is driven before the uncoupling site 18. After the drive unit 12 passes through, the leading assembly carriage 4 is uncoupled with the already assembled part and pushed further into the area of the test bench 22. The assembly carriage 4 that follows is now driven by the drive unit 12 and draws the chain of assembly carriages 4 through the assembly line. After traversing the test bench 22 and delivering the tested part, the now empty assembly carriage 4 is again coupled, at the end of the chain, with the last assembly carriage 4.

The inventive device for conveying assembly carriages makes work on an assembly line possible. The entire assembly works are stabilized from the pre-assembly via a commission area up to the test bench by uniform working along the assembly line. Thereby fluctuations in production can be prevented, which leads to an increase in productivity. The device is extraordinarily flexible, needs little upkeep and is economical. The drive unit of the assembly carriages can be disassembled within a short period of time and again mounted at another location. It is easily possible to extend or shorten the assembly line. The individual assembly carriages can be separated from one another on their drawbars and then easily pushed, by the hired personnel, to a desired position, even outside the guide rail or the process chain, since the assembly carriages are independent of the drive unit and can be even rolled upon their wheels on the floor.

1. Device (2) for conveying assembly carriages (4) in a process chain comprising a plurality of assembly carriages (4) and one drive device (12), characterized in that each assembly carriage (4) has a drawbar (10) by which the assembly carriages (4) can be interconnected, said assembly carriages (4) being guided on a guide rail (6) and that on a place of said process chain one drive device (12) drives only one of the interconnected assembly carriages (4).

2. Device (2) according to claim 1, characterized in that said drive unit (12) drives the assembly carriages (4) that leads at the time.

3. Device (2) according to claim 1 or 2, characterized in that on said drive unit (12) drives (14, 20) are provided which engage in the driven assembly carriages (4).

4. Device (2) according to any one of claims 1 to 3, characterized in that said drawbar (10) is flexibly situated on the assembly carriage (4) in order to be able to follow each route survey of said guide rail (6).

5. Device (2) according to any one of claims 1 to 4, characterized in that said guide rail (6) is fixed on the floor.
